(19) United States
(12) Patent Application Publication
(10) Pub. No.: US 2007/0123275 A1
(43) Pub. Date: May 31, 2007

(54) TELECOMMUNICATION ADVERTISING SYSTEM

(76) Inventor: Numair Faraz, Malibu, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/536,392

(22) Filed: Sep. 28, 2006

Related U.S. Application Data
(60) Provisional application No. 60/721,568, filed on Sep. 28, 2005.
(60) Provisional application No. 60/751,725, filed on Dec. 19, 2005.

(51) Int. Cl. H04Q 7/20

(52) U.S. Cl. 455/461

(57) ABSTRACT

An advertising/revenue generation system for use with telecommunication systems. A database can be organized or sorted on parameters relating to telecommunication, such as caller demographics, time and place of a call, and the services of the initially dialed number. Advertisers can submit advertisements to the advertising system. When a caller submits a communication request, for example by entering a telephone number into a communication device, the advertising system recognizes the request and accesses the database. The advertising system determines advertisements that are related to the caller's communication request and telecommunicates relevant advertising content to the caller. The content can be provided before, during, and/or after the caller establishes communication as initially requested. The advertising system can provide incentives to callers to select ads, can collect fees from advertisers for submitting their ads to callers, and can pay commissions to telecommunications carriers for supporting communication.

### CROSS-REFERENCE TO RELATED APPLICATIONS

This application claims the priority benefits of U.S. Provisional application 60/721,568, filed Sep. 28, 2005 and 60/751,725, filed Dec. 19, 2005 which are both incorporated herein in their entireties by reference.

### BACKGROUND OF THE INVENTION

1. Field of the Invention

The invention relates to the field of telecommunication and advertising and revenue generation therewith.

2. Description of the Related Art

Telecommunications have become an increasingly common and convenient means of personal communication. Individuals commonly employ telecommunications to communicate with friends and family as well as with business colleagues. Telecommunications also provide a popular and convenient avenue for obtaining information, goods and services. While telecommunications remain a particular popular and useful means of communication, there exist limitations in existing systems in providing desirable and useful information to users.

One limitation in existing telecommunications systems is that they are generally configured as directed point-to-point communications systems. For example, a given caller enters a particular telephone number to establish directed communication with a particular target. This generally requires that the user either know or have stored a telephone number that they wish to call.

There can frequently arise conditions wherein a caller may benefit from and welcome being provided with previously unknown contact information, however existing telecommunications systems lack the ability to conveniently present this information. For example, a caller may be unaware of a recently opened restaurant that is more conveniently located and offers better prices and wider variety of menu choices than the restaurant that they typically call for placing food orders. Such a caller would likely benefit from and value being presented with information relating to the new restaurant, however may forgo the benefits of this information until they become aware of the new restaurant.

Limitations also exist in existing telecommunications systems for efficiently and conveniently presenting advertisements to users in a telecommunications system. For example, an advertiser or provider of goods and services can call a user to inform them of their products and services in a well-known “telemarketing” system. However, such calls placed at the initiative of the advertiser/goods and service provider are often felt by the recipient to be an inconvenient and unwelcome intrusion.

A further limitation is that existing telecommunications systems do not provide an effective mechanism for informing a third party advertiser or service provider when a caller has manifested an interest in products or services provided by the advertiser or provider. For example, a caller may place a call to a plumbing business thereby exhibiting an interest in obtaining plumbing services. Another plumbing service in the area would be particularly interested in informing the caller of their services, location, prices, etc. in hopes of obtaining a new customer.

However, as the telecommunication between the caller and the called plumbing service is a directed point-to-point communication, the third party plumbing service remains unaware of the manifested interest of the caller in obtaining plumbing services. The caller forgoes the advantage of obtaining services from the third party plumbing business that might offer more advantageous pricing, more convenient scheduling, and/or higher quality service. The third party plumbing business misses the opportunity to expand their business.

### SUMMARY OF THE INVENTION

From the forgoing, it will be appreciated that there exists a desire for improved telecommunications systems and methods of operating telecommunications systems to provide increased capabilities and flexibilities in presenting and sharing information and options among various users. There exists a need for callers to be provided with relevant content when they have manifested a desire to establish communication with goods and service providers while avoiding the presentation of such content when it might be more likely perceived as intrusive and unwanted.

There is also a need for improved systems and methods for informing advertisers and/or goods and service providers when a user has exhibited a desire for obtaining similar goods and services. It would be desirable to provide a telecommunications system that provides advantages to an initiator, a carrier, and a recipient of a telecommunication link. For example, it would be advantageous for a caller to be conveniently provided with information related to new service providers offering desired features. It would be valuable for a carrier to receive benefits for supporting and facilitating such a telecommunications system. It would also be beneficial for a service provider or advertiser to gain access to users more likely to be interested in their services.

These needs are satisfied by the invention that in one embodiment includes a telecommunication system wherein a user can designate a first target for communication establishment via a communication device and, upon designation of the first communication target, the system is adapted to automatically present the user with content for at least a second related communication target via the communication device.

Another embodiment includes a method of providing advertising in a telecommunication system, the method comprising creating a database including a plurality of parameters indicative of parties of a telecommunication system, determining that a caller has indicated a first desire to establish communication, sorting the database based at least partially on parameters of the caller's first indicated communication desires, and telecommunicating content to the caller wherein the content is related to the caller's first indicated communication desires.

A further embodiment includes a system for providing advertising in a telecommunication system comprising means for storing and indexing data, means for communication between parties of the telecommunication system, and means for telecommunicating content to a first party from a second party wherein the content is related to a communication request made by the first party. These and other objects and advantages of the invention will become more apparent from the following description taken in conjunction with the accompanying drawings.

### BRIEF DESCRIPTION OF THE DRAWINGS

FIG. 1 illustrates a high-level block diagram of one embodiment of a telecommunication system including an advertising/revenue system.

FIG. 2 illustrates schematically one embodiment of a telecommunication device portraying a first communication target identifier and content corresponding to a plurality of second communication targets.

FIG. 3 illustrates schematically a second embodiment of a telecommunication device portraying a first communication target identifier and content corresponding to a plurality of second communication targets.

FIG. 4 illustrates a high-level flow diagram of one embodiment of a system and method for providing advertising in a telecommunications system.

FIG. 5 is a block diagram of one embodiment of a telecommunication advertising system.

FIG. 6 is a schematic illustration of one embodiment of providing related content in a telecommunications system.

FIG. 7 is a block diagram of one embodiment of an advertising database in a telecommunications system.

### DETAILED DESCRIPTION OF THE PREFERRED EMBODIMENT

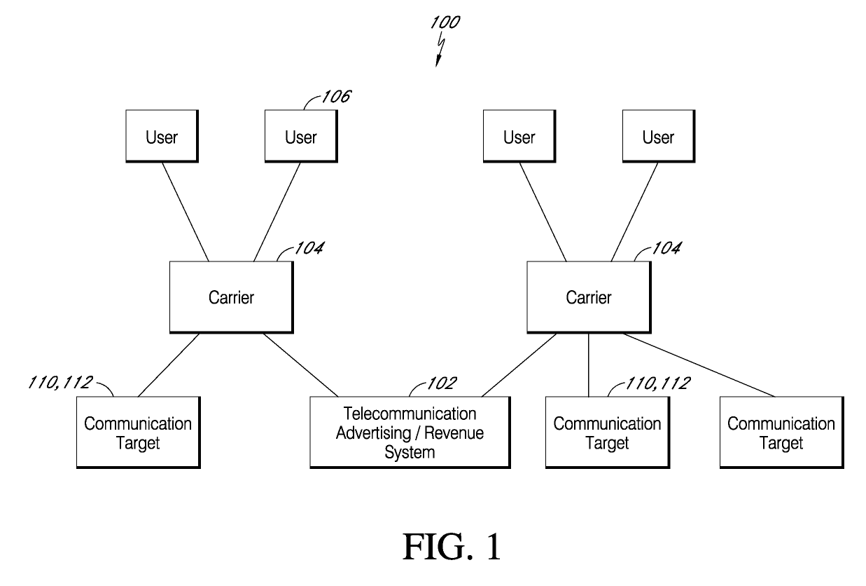

FIG. 1 illustrates a high-level block diagram of one embodiment of a telecommunications system 100 including an advertising/revenue system 102. The advertising/revenue system 102 is adapted to provide increased capabilities and flexibilities in sharing valued information among users 106 of the telecommunications system 100 and telecommunication targets and/or advertisers 110, 112. In certain aspects, the advertising/revenue system 102 is adapted to more efficiently provide users 106 with timely and relevant information. In certain implementations, the advertising/revenue system 102 is adapted to more effectively match telecommunication targets and/or advertisers 110, 112 with users 106 likely to be interested in their services.

In one embodiment, the telecommunications system 100 includes one or more carriers 104 that facilitate communication within the system 100. In one embodiment, the carriers 104 comprise landline or wired telephony service providers, such as Plain Old Telephone Service (POST). In certain embodiments, the carriers 104 comprise cellular telephony services. In certain embodiments, the carrier 104 comprise voice over digital network services wherein a users 106 voice signals are digitized and transmitted digitally over a multi-node network. In one embodiment, this can include a Voice over Internet Protocol (VoIP) system.

It will be understood that in various embodiments, communication among various elements of the system 100 can comprise multiple types of communication protocols. This can include multiple different protocols in a single communication as well as different types of protocol in different communication directions. For example, in one embodiment, a user 106 can place a voice-based communication, such as via a landline or cellular telephony call. The user 106 can receive a text or other graphics based communication that need not necessarily include voice protocol communication. In certain embodiments, the user 106, for example, may send and/or receive a communication including both voice protocol and text or other graphics based communication protocols in combination.

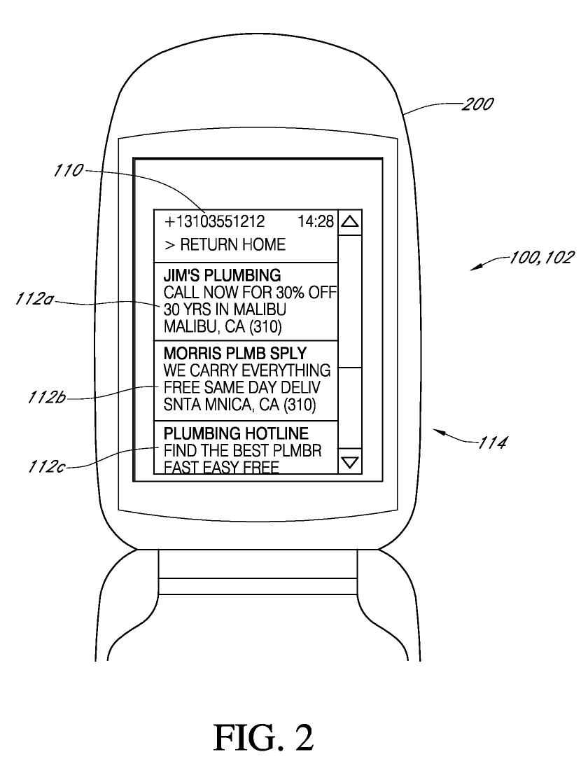

FIG. 2 illustrates schematically one embodiment of a telecommunication device 200 in a telecommunication system 100 offering an advertising/revenue system 102. In this embodiment, the telecommunication device 200 comprises a cellular telephony hand set. However, it will be understood that in other implementations, a telecommunications device 200 comprising a head set apparatus, a wired or wireless landline telephony set, personal computer, personal digital assistant (PDA) and/or other types of telecommunication devices 200 can be advantageously employed according to one or more embodiments as described herein.

In this embodiment, a user 106 has indicated a first telecommunication target 110 corresponding, in this implementation, to a numeric telephone number. In certain embodiments, indicating a first telecommunication target 110 comprises sequentially entering the digits of a phone number. In other embodiments, the indicating the first communication target 110 comprises selecting a presented number, for example using a graphical user interface (GUI) cursor. The presented number can be selected from a pre-defined list, e.g. a list of contacts and/or can be selected from a newly generated list, e.g. from a directory assistance search. In certain embodiments, the user 106 can indicate a first telecommunication target 110 via a surrogate symbol and/or image. For example, a user 106 can direct a cursor to text reading “Bob's Plumbing” to indicate their interest in contacting the associated plumbing business, but an associated telephone number need not be displayed or entered by the user 106.

In response to the indication of the first communication target 110, the system 100, 102 provides the user 106 with related content 114. In one embodiment, the related content 114 corresponds to a plurality of possible second communication targets 112a, 112b, and 112c. In this embodiment, the possible second communication targets, 112a-112c are related to the first indicated communication target 110 by sharing a common industry, e.g. plumbing services. In this embodiment, the content 114 corresponding to possible second communication targets 112a-112c is presented graphically as text based data corresponding to the services and contact information for the second communication targets 112a-112c. In one implementation, the content 114 provided by the system 100, 102 can be considered as targeted advertising related to the users 106 manifested interest in establishing communication with the first communication target 110.

Thus, in one implementation, the user 106 is provided with content 114 that is related to their manifested desire to establish communication. The content 114 can inform the user 106 of possible second communication targets 112a-112c that might offer more convenient times and/or locations of service, better pricing, and/or higher quality ratings than that of their initially selected first communication target 110. As in certain embodiments, the system 100, 102 provides the content 114 to the user 106 upon their indication of a first communication target 110, the likelihood that the user 106 would perceive the content 114 as intrusive or unwanted is reduced.

In addition, the content 114 can be provided to the user 106 in a variety of timely manners. In certain embodiments, the content 114 is provided to the user 106 before establishment of communication with the first communication target 110. For example, the user 106 can enter/select a telephone number for the first communication target 110 with the telecommunication device 200. The system 102 is, in certain embodiments, adapted to present the content 114 before communication is established with the first communication target 110. This provides the user 106 the option of selecting the content 114 rather than completing a connection with the first communication target 110.

In certain embodiments, the system 102 is adapted to present the content 114 for an extended period. For example, in one embodiment, while the user 106 is communicating with the first communication target 110, the content 114 continues to be provided. If, for example, the first communication target 110 provides less than satisfactory pricing, availability, etc. the user 106 can select the content 114 to explore other options.

In certain embodiments, the content 114 is available to the user 106 after completing communication with the first communication target 110. The content 114 can include coupons or advertisements that the user 106 can save for later use. In certain embodiments, the system 100 is further configured such that a user 106 can access a desired portion of the content 114 at a later time. For example, in one embodiment, the user 106 can select one or more items from the content 114 that are of interest to save for later use.

The system 100, 102 also provides the advantage to the possible second communication targets 112a-112c of presenting the content 114 corresponding to their services to the user 106 at a time when the user 106 has clearly manifested an interest in obtaining services similar to those provided by the possible second communication targets 112a-112c. The system 110, 102 thus facilitates presenting telecommunication possibilities between users 106 and second communication targets 112 in a convenient manner and in a manner matching parties likely having a high level of interest in each other.

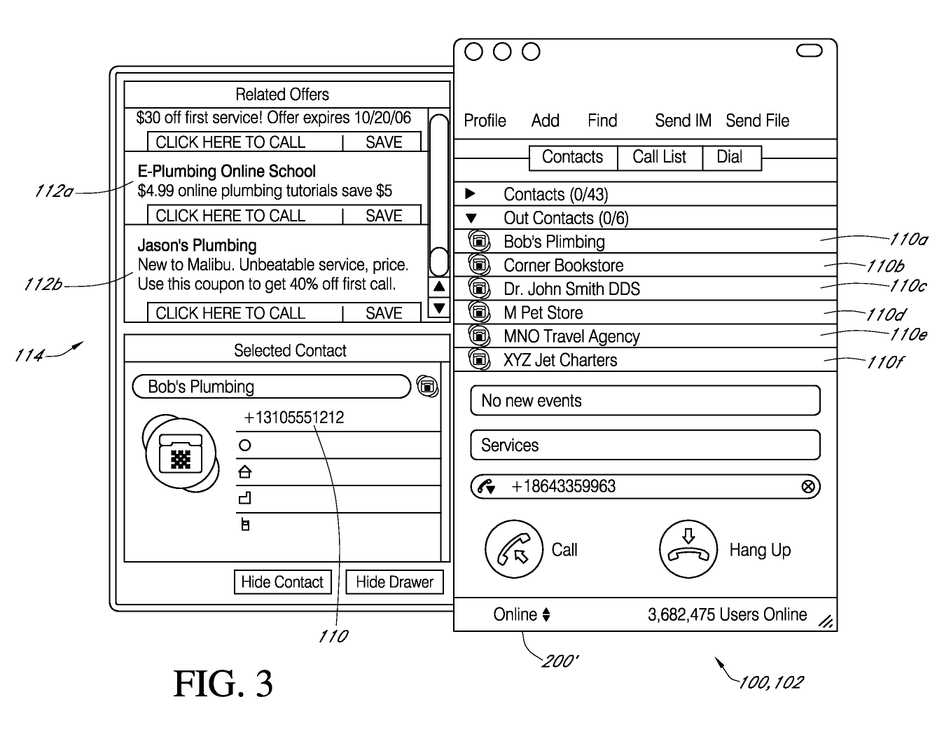

FIG. 3 illustrates schematically another embodiment of a telecommunication device 200′ in a telecommunication system 100 including an advertising/revenue system 102. In this embodiment, the telecommunication 200′ comprises a personal computer configured for voice over digital network capability, a PDA including voice and graphics communication capability and/or an advanced cellular telephony set including voice and graphics communication capability.

FIG. 3 also illustrates that in certain implementations, the system 100, 102 provides support for a plurality of first communication targets 110. For example, a user 106 may have multiple first communication targets corresponding, for example, to plumbing services 110a, a book store 110b, a dentist 110c, a pet store 110d, a travel agency 110e, and charter jet services 110f. Upon selection of a first communication target 110a corresponding to plumbing services, the system 100, 102 presents content 114 corresponding to one or more possible second communication targets 112a, 112b also related to plumbing services.

The content 114 can include discounts or coupons as incentives for the user 106 to select one or more of the second communication targets 112a, 112b. Alternatively, the system 100, 102 also fully supports establishment of communication between the user 106 and the first communication target 110, thereby providing advantageous options to the user 106 without compromising or impairing their ability to establish communication as originally desired.

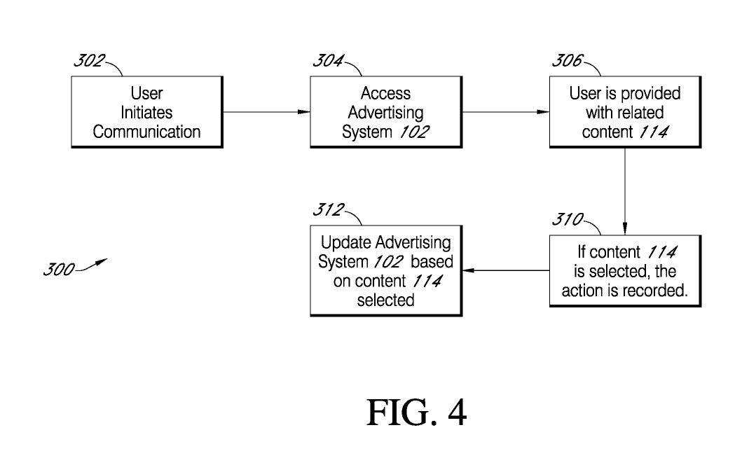

FIG. 4 illustrates a process flow of one embodiment of a method of providing advertising and/or revenue generation in a telecommunication system, referred to hereafter as the method 300 for brevity. In a first block 302, a user 106 initiates communication. As previously indicated, the block 302 can include actual placement of a telecommunication call, however can also include simply indicating a desired communication. For example, the block 302 can include a user 106 indicating a desired communication target without actual establishment of the communication.

Following block 302 is a block 304 wherein access is made to the advertising/revenue system 102. The access of block 304 includes sharing of information indicative of the user's 106 intention from block 302. Thus, in various implementations, the accessing of block 304 can include sharing of information related to the user's identification, the user's location, the time and date of the initiation of block 302, the identification of the user's indicated communication target, a geographic location of the intended communication target, and/or other related parameters of the user's indicated communication desires from block 302. It will be understood that in certain embodiments the access of block 304 can include historical data, for example, data indicative of the user's 106 previous communication history.

Following from the access of block 304, the user 106 is provided with related content 114 in a block 306. As previously noted, the content 114 is related to the user's 106 initial communication request from block 302. For example, the content 114 can correspond to similar services to the user's initial communication of block 302. The provision of content in block 306 can occur prior to the establishment of the communication requested in block 302, concurrently with establishment of communication requested in block 302, and/or following the communication requested in block 302.

Thus, in one implementation, the content 114 provided in block 306 can include advertisements or coupons for services related to those requested initially in the block 302 which the user 106 can store or save for later use. In certain implementations, the content 114 provided in block 306 can be elected instead by the user 106 such that the communication initially requested in block 302 is not established as initially requested but instead the user 106 establishes communication with an alternative second communication target 112.

In a block 310, if the content from block 306 is selected, this action is recorded. The recording of block 310 provides trending and historical recordation of usage of the system 100, 102. This can be utilized in a block 312 to update the advertising/revenue system 102 based on the content 114 selected. For example, if a user 106 selects a particular second communication target 112, the method 300 can record and update this data, for example to increase the ranking of the second communication target 112 selected. In one embodiment, selection of the content 114 in a block 310 can result in a fee from a second communication target 112 for selection of their content 114. Similarly, a commission can be paid to a carrier 104 for providing the user 106 with the content 114.

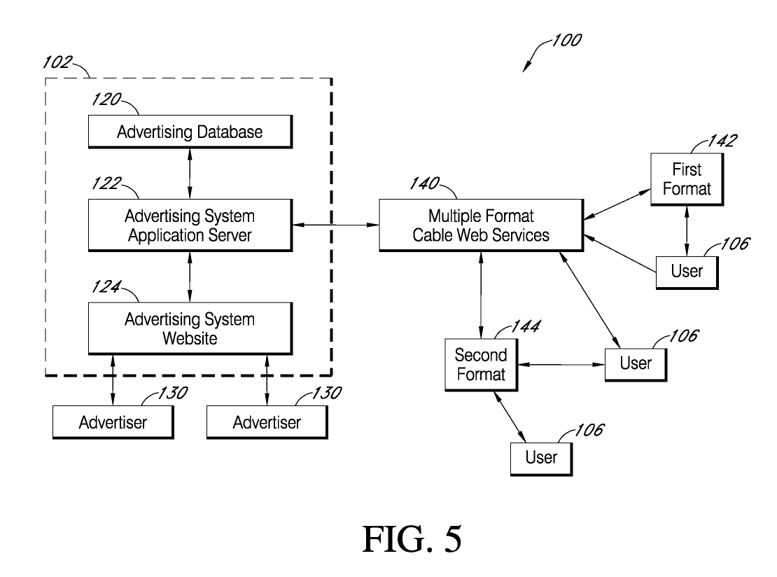

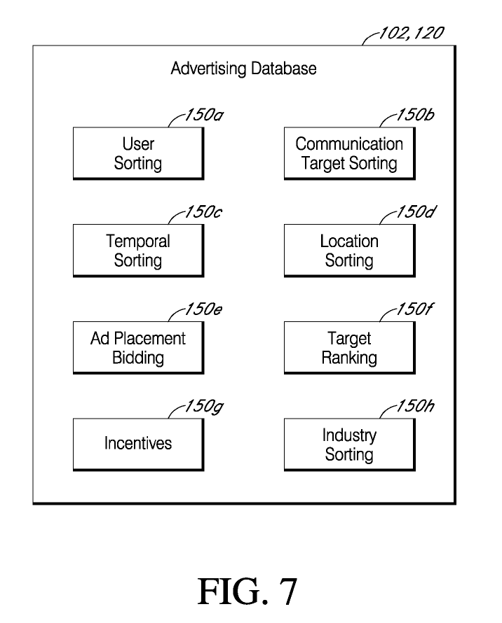

FIG. 5 illustrates one embodiment of a telecommunication system 100 including an advertising/revenue system 102. In one embodiment, the advertising/revenue system 102 comprises an advertising database 120. The advertising database 120 stores data to facilitate the system's 102 ability to more efficiently provide relevant content 114 to users 106. In various implementations, the advertising database 120 can include information related to a user's previous calling history, a plurality of advertisements that can be provided as the content 114, and/or records of fees to be selected and commissions to be paid. As will be understood by one of ordinary skill, the advertising database 120 can be arranged in a plurality of configurations and can be organized or sorted on a plurality of parameters. Various exemplary implementations of organizational parameters will be described in greater detail following with reference to FIG. 7.

In one embodiment, the advertising/revenue system 102 also comprises an advertising system application server 122. The application server 122 provides a management and control function to the system 102. For example, in one embodiment, the application server 122 is adapted to access the advertising database 120 and obtain relevant content 114 based on the particulars of a given user's call.

In certain implementations, the application server 122 also facilitates establishment of a communication between a user 106 and a second communication target 112 based on selection of the content 114. For example, upon selection of content 114 of interest, a user's 106 communication request can pass through or be brokered by the advertising/revenue system 102 for connection to the second communication target 112. This aspect facilitates tracking of use of the system 102 to facilitate updating of the advertising database 120. For example, in one embodiment, upon selection of content 114 by the user 106, the application server 122 updates in the advertising database 120 that a commission is due a carrier 104 for supporting the communication and a fee is due from a second communication target 112 for the user 106 selecting content 114 associated with that second communication target 112.

In various implementations, the advertising database 120 and application server 122 comprise both long term memory or storage as well as short term memory that can comprise volatile memory. The advertising database 120 and application server 122 can be implemented as a microprocessor based system with appropriate operating software. The advertising database 120 and application server 122 can be implemented as a stand-alone centrally located system, a local area network (LAN), and/or a wide area network (WAN).

In one embodiment, the advertising/revenue system 102 further comprises an advertising system website 124. The advertising system website 124 provides a convenient interactive system for access to the advertising/revenue system 102. In one embodiment, advertisers 130 can access the advertising system website 124, for example to create or update an advertisement, to submit payment for services, and/or to place bid amounts for content 114 relating to their business.

In certain implementations, access by an advertiser 130 to the advertising system website 124 proceeds in a secure manner, for example requiring a particular encryption protocol and/or appropriate passwords or security codes. These implementations provide the advantage of maintaining confidentiality between a given advertiser 130 and other advertisers 130 also employing services of the advertising/revenue system 102. For example, a first advertiser 130 can bid for placement of content 114 associated with their business via the advertising system website 124, however without access to information related to bids or advertisements of other advertisers 130.

In one embodiment, the system 100 also includes multiple format capable network services 140. The network services 140 are adapted to support a plurality of communication formats and protocols. FIG. 5 illustrates that the network services 140 are adapted to support communication with a first format 142 and a second format 144. It will be understood, however that a wide variety of communication formats and capabilities exist and are in continuing development. Thus the illustration and description of the first format 142 and second format 144 are simply illustrative of one embodiment and can be readily adapted by one of ordinary skill to support additional existing formats and formats to be developed.

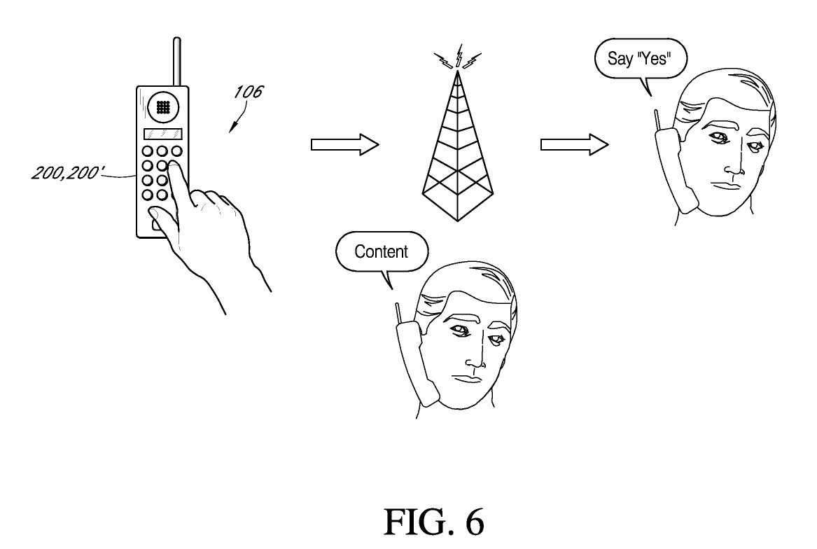

In one embodiment, the first format 142 comprises voice telephony, such as wired or land line telephony and cellular voice telephony. Thus, in one embodiment, the system 100, 102 is adapted to support voice based communication. In one embodiment, the communication via the user 106 and the communication targets 110, 112 proceeds as voice communication. In this embodiment, the content 114 is also provided to the user 106 as an audible message and the user 106 has the option of selecting the content 114 via a voice based response as shown in FIG. 6.

In one embodiment, the second format 144 comprises expanded communication capabilities, such as combining voice and text or other data. For example, in various implementations, the second format 144 can comprise one or more VoIPs. The second format 144 can comprise third generation (3G) or later advanced cellular telephony systems, for example including short message services (SMS). Thus, in certain embodiments, communication between a user 106 and the advertising/revenue system 102 can proceed via both voice based and text or other data based formats. These embodiments provide expanded capabilities in presenting the content 114 to the user 106 as well as for the user 106 to select and store the content 114.

The multiple format capable network service 140 also provides increased flexibility in utilization of the capabilities of the advertising/revenue system 102. For example, in one implementation, voice communication between a user 106 and a communication target 110, 112 can proceed in a bidirectional or full duplex manner as many people have become accustomed to in telecommunication.

The advertising/revenue system 102 can also support presentation of the content 114 in an asynchronous half-duplex manner. For example, in one implementation, text or other graphics based content 114 can be provided to the user 106 while the user 106 is conducting a voice communication without interruption or otherwise disturbing their full duplex voice telecommunication. Thus, the advertising/revenue system 102 can present the user 106 with additional information and options with reduced impact on their existing expectations for voice communication.

FIG. 7 illustrates one embodiment of an advertising database 120 of a telecommunication advertising/revenue system 102. As indicated in FIG. 7, the advertising system database 120 comprises a plurality of parameters 150 under which the database 120 can be accessed or managed to facilitate operation of the system 102.

In one embodiment, the advertising database 120 comprises a parameter data that can be linked by a user's identification, e.g. their telephone number, to provide more relevant content 114 to the user. For example, the user sorting parameter 150a can include the user's 106 gender, age, marital status, previous calling history, social and/or business relationships, etc.

In one embodiment, the advertising database 120 also comprises a communication target sorting parameter 150b. In this embodiment, the system 102 can correlate or sort the content 114 to be provided based at least partially on an identification of the communication target. For example, if a user 106 indicates their desire to establish communication with a first communication target 110 that provides pizza delivery services, the advertising database 120 can be sorted to provide content 114 related to other pizza delivery services.

In one embodiment, the advertising database 120 comprises a temporal sorting parameter 150c. In this embodiment, the system 102 can sort the advertising database 120 based on a time and date parameter. For example, should a user 106 place a call on Mother's Day or Valentine's Day, the system 102 can provide content 114 including advertisements or contact information for florists and/or restaurants. Similarly, should a user access their communication device 200, 200′ in the late afternoon to early evening, the system 102 may provide content 114 including advertisements or contact information for food pickup or delivery services.

In one embodiment, the advertising database 120 comprises a location sorting parameter 150d. In this embodiment, the system 102 can access or manipulate the advertising database 120 based at least partially on the location of the communication. For example, as previously noted, in certain embodiments the advertising database 120 can include demographic information related to a user 106 including their home and/or mailing address. If the user 106 indicates a desire to establish communication in a geographical area significantly different from their home or billing address, the system 102 can present content 114 that is geographically appropriate. For example, if the user 106 initiates communication in a geographic location having many recreational opportunities, the system 102 can predict that the user 106 may be on vacation and can present content including contact information for museums, guide services, golf courses, etc. If the user 106 initiates communication indicating they are recently arrived at an airport, the system 102 can provide content 114 including contact information for local hotels, taxi services and/or rental car agencies.

In certain embodiments, the advertising database 120 includes an ad placement bidding parameter 150e. In certain embodiments, advertisers 130 can pay a proportional fee to increase the prominence with which their advertisements or contact information is presented in the content 114. For example, in certain implementations, an advertiser 130 can pay an increased fee to have their advertisement placed first or earlier in a listing of a plurality of advertisements. In other aspects, an advertiser 130 can pay an increased fee for a larger advertisement, an advertisement including color and/or other attractive graphics and/or an interactive link to make selection of their advertisements more convenient for the user 106.

In certain embodiments, the advertising database 120 comprises a target ranking parameter 150f. In certain embodiments, the advertising database 120 can include a feedback feature such that an advertiser 130 can accumulate a quality ranking from previous user's experiences with that advertiser. In other aspects, the target ranking parameter 150f can comprise a frequency or count aspect. For example, advertisers 130 whose content 114 is more frequently selected can accumulate a popularity ranking. The content 114 can thus in certain embodiments be presented in rank order based on the frequency with which the advertisers content 114 has been historically selected.

In certain embodiments, the advertising database 120 also comprises an incentives parameter 150g. As previously noted, the advertising/revenue system 102 can include a plurality of incentives for users 106, carriers 104, and/or advertisers 130 to utilize the system 102. In one implementation, users 106 can receive the incentive of reduced cost or free telecommunication services for establishing contact in response to the content 114. In certain implementations, a carrier or provider of telecommunication services 104 can receive a commission or payment for supporting communication between the users 106 and advertisers 130. The advertisers 130 can pay fees for the incentive of having their content 114 be provided to the users 106 by the system 102 such that the content 114 is received by users 106 having a high likelihood of interest in the advertisers services.

In certain embodiments, the advertising database 120 comprises an industry sorting parameter 150h. If a user 106 initiates communication with a given communication target, the system 102 can be adapted to cross-reference the advertising database in an industry sorting parameter 150h to generate content 114 corresponding to related industries. For example, should a user 106 initiate a call to a plumbing services company or query a directory assistance for plumbing services contact information, the system 102 can cross-reference the advertising database 120 to generate content 114 providing contact information for advertisers 130 providing plumbing services. In another embodiment, if a user 106 completes a call to a first communication target 110a comprising an airline, the system 102 can conclude that the user 106 successfully obtained the desired flight reservation services. As a component of the industry sorting parameter 150h, the system 102 can provide content 114 in a related industry, for example contact information for rental car agencies.

Thus, various embodiments of the advertising/revenue system 102 provide advantages to multiple parties in a telecommunication system 100. Users 106 can obtain the benefits of timely and relevant content 114 that can inform them of opportunities and new contacts which they might otherwise be unaware of or that might otherwise require determined effort to acquire. The content 114 can be provided to a user 106 when the user 106 has already exhibited interest in related information or services. This aspect reduces the likelihood that the content 114 will be perceived as intrusive or unwelcome.

Embodiments of the advertising/revenue system 102 can provide the advantages to carriers or communication services providers 104 of a direct revenue stream as well as increased customer traffic. For example, carriers 104 can receive commissions when users 106 or advertisers 130 utilize their telecommunication services as part of the system 100. The advertising/revenue system 102 can also be configured to provide incentives to users 106 and advertisers 130 encouraging their use of the system 100 such that even absent a direct revenue stream, the carriers 104 receive the benefits of increased utilization of their telecommunication services in response to use of the system 102.

Advertisers 130 receive the benefits of having their advertisements and/or contact information provided to users 106 in a particularly timely and relevant manner. Advertisers 130 also receive the advantage of exposure of their services to a user 106 who may be initially trying to contact a competitor. Advertisers 130 also receive the advantage of being able to configure the parameters under which an advertising database 120 presents their services as content 114 to a user 106. The system 102 also supports the ability for an advertiser 130 to bid proportionately for a display priority of their ad to increase the likelihood of a user 106 selecting their ad for further contact.

Although the above disclosed embodiments have shown, described and pointed out novel features of the invention as applied to the above-disclosed embodiments, it should be understood that various omissions, substitutions, and changes in the form of the detail of the devices, systems and/or methods illustrated may be made by those skilled in the art without departing from the scope of the present teachings. Consequently, the scope of the invention should not be limited to the foregoing description but should be defined by the appended claims.

What is claimed is:

1. A telecommunication system wherein a user can designate a first target for telecommunication establishment via a communication device and wherein, upon designation of the first telecommunication target, the system is adapted to automatically present the user with content for at least a second related telecommunication target via the communication device.

2. The system of claim 1, wherein the system is adapted to support communication between at least one of the user and the communication targets via at least one of voice over digital network telephony and cellular telephony.

3. The system of claim 1, wherein the content is provided as a voice message to the user.

4. The system of claim 1, wherein the content is provided graphically to the user.

5. The system of claim 1, wherein the at least second communication target pays a fee to be presented as the content.

6. The system of claim 1, wherein the system is adapted to automatically establish telecommunication between the user and the at least second communication target upon selection of the content by the user.

7. The system of claim 1, comprising a content database configured such that the content can be presented to the user related to one or more of a user's identification, geographical location, time of the communication, an industry of the first communication target, and a ranking of the second communication target.

8. The system of claim 1, wherein the content is adapted to represent a ranking of at least one of a quality feedback rating of the second communication target and a fee paid by the second communication target to be presented as the content.

9. The system of claim 1, wherein the system is adapted to store data indicative of the selection of the content.

10. The system of claim 9, wherein the system is further adapted to update the content based at least partially on the previous selection of the content.

11. The system of claim 1, wherein the system provides financial incentives for selection of the content.

12. The system of claim 11, wherein the incentives comprise one or more of reduction in a communication cost for the user, a payment to a carrier of the communication, and payment by the second communication target in selection of the content.

13. A method of providing advertising in a telecommunication system, the method comprising:
creating a database including a plurality of parameters indicative of parties of a telecommunication system;
determining that a caller has indicated a first desire to establish communication;
sorting the database based at least partially on parameters of the caller's first indicated communication desires; and
telecommunicating content to the caller wherein the content is related to the caller's first indicated communication desires.

14. The method of claim 13, wherein creating the database comprises creating the database having sortable parameters of at least one of caller demographics, industry grouping, time of call, location of call, and content ranking.

15. The method of claim 13, wherein determining that the caller has indicated the desire to establish communication comprises identifying a target identification during a communication establishment process.

16. The method of claim 15, comprising providing the related content prior to establishment of the caller's first indicated communication desires.

17. The method of claim 13, further comprising updating the database based at least partially on selection of the content by the caller.

18. A system for providing advertising in a telecommunication system comprising:
means for storing and indexing data;
means for communication between parties of the telecommunication system; and
means for telecommunicating content to a first party from a second party wherein the content is related to a communication request made by the first party.

19. The system of claim 18, wherein the means for storing and indexing data comprises a database configured to store and sort data indicative of a plurality of parameters of communication within the telecommunication system and wherein the application server is configured to sort the data based on one or more of the parameters to present the related content.

20. The system of claim 18, wherein the means for communication comprises an advertising system website configured to allow the second party to submit the related content and to indicate parameters under which they wish the content to be telecommunicated to the first party.

21. The system of claim 18, wherein the means for communication comprise one or more of a cellular telephony system, a wired telephony system, and a voice over digital network system.
